(19) United States
(12) Patent Application Publication
(10) Pub. No.: US 2002/0020064 A1
(43) Pub. Date: Feb. 21, 2002

(54) Cleaning device for a shaving apparatus

(76) Inventor: Norbert Kunze, Diez (DE)

Correspondence Address: Jack E. Haken, U.S. Philips Corporation, 580 White Plains Road, Tarrytown, NY, 10591, US

(21) Appl. No.: 09/832,720

(22) Filed: Apr. 11, 2001

(30) Foreign Application Priority Data
Apr. 14, 2000 (DE) 10018486.3

(51) Int. Cl. B26B 19/38

(52) U.S. Cl. 30/41; 30/43.6; 30/34.05

(57) ABSTRACT

The invention relates to a shaving apparatus having an electric drive, having a rotary shaving head provided with cutting members (3), and having a shear foil (4). The invention is characterized in that a cleaning device (6) is included, which device cleans the shaving head (1) during operation, and the drum-shaped shaving head (1) is rotatable about its longitudinal axis and carries at least one cutting member (3) on the circumference of its cylindrical core (2), which cutting member is rod-shaped and extends in the longitudinal direction of the shaving head (1).

The invention relates to a shaving apparatus having an electric drive, having a rotary shaving head provided with cutting members, and having a shear foil.

From DE 3342243 Al an electrically powered shaving apparatus is known, which apparatus has a housing for the drive unit and having a cutting member of a shaving head, which cutting member is covered with a shear plate. The cutting member takes the form of a cutting roller which is rotationally driven by a drive unit, which roller is formed with a double-threaded helical groove, whose trailing edge is formed as a cutting edge.

It is an object of the invention to provide a concept for a shaving head which can be cleaned simply, which can be manufactured simply and which provides invariably satisfactory shaving results both for short and long facial hairs.

According to the invention the object is achieved in that a cleaning device is included, which device cleans the shaving head during operation, and the drum-shaped shaving head is rotatable about its longitudinal axis and carries at least one cutting member on the circumference of its cylindrical core, which cutting member is rod-shaped and extends in the longitudinal direction of the shaving head. The rotary movement of the drum-shaped shaving head results in simple cleaning because the cutting member of the shaving head permanently rotates underneath the shear foil, as a result of which cleaning need not be effected between the shaving head and the shear foil but can take place in areas which are remote from the shear foil. Thus, cleaning is possible during shaving.

The embodiment defined in claim 2 provides a particularly simple possibility of cleaning the shaving head during shaving. A cleaning brush can be arranged, for example, underneath the rotary shaving head, said brush being constantly in contact with the cutting members of the shaving head and thereby removing the shaving particles from said cutting members.

The embodiment defined in claim 3 enables the shaving head to be manufactured simply and cheaply. When the cutting member consists of spring wire of preferably rectangular cross-sectional shape, the spring wire can simply be wound onto a cylindrical core. The shaving head is ready after cylindrical grinding on a commercially available cylindrical grinding machine.

The cleaning device as defined in claim 4 is particularly cheap because it only consists of a stationary brush arranged at the shaving head side remote from the shear foil. As a result of the rotation of the shaving head the shaving particles are combed out of the cutting members by the brush.

The embodiment defined in claim 5 provides improved cleaning in that the cutting member has a spiral shape. A brush which is also spiral-shaped better engages into the gaps of the shaving head and cleans these more thoroughly.

The embodiments defined in claim 6 and claim 7 provide two convenient possibilities of removing and collecting shaving particles left behind by the cleaning device. The removal of the shaving particles into a receptacle can be effected solely by means of centrifugal forces produced during the rotation of the shaving head. If these forces are not adequate, an additional removal device may be provided, which can, for example, consist of rotary brushes with a stripper.

Claim 8 defines an advantageous construction of the receptacle. A receptacle in the form of a removable drawer allows the shaving particles to be removed simply from the shaving apparatus.

The embodiment defined in claim 9 ensures a gentle cooperation with the shear foil. The slits of the shear foil are adapted to the pitch of the spiral-shaped cutting member so as to obtain an acute angle between the cutting member and the edges of the slits in the shear foil, to which edges the cutting member runs in an axial direction. As a result of this, the web portions of the shear foil, which tend to project into the path of axial movement of the cutting member, are always moved up by the cutting member starting from their bases and lifted onto the cutting member, so that damage to the web portions is precluded.

The embodiment defined in claim 10 improves the shaving performance. The rotary movement of the shaving head with the spiral-shaped cutting member in conjunction with the lifting of the web portions of the shear foil leads to a perfect cutting of facial hairs. In order to provide the necessary contact between the shear foil and the cutting member the shear foil is urged against the cutting member under spring load.

An embodiment of the invention will be described in more detail, by way of example, with reference to the drawings. In the drawings:

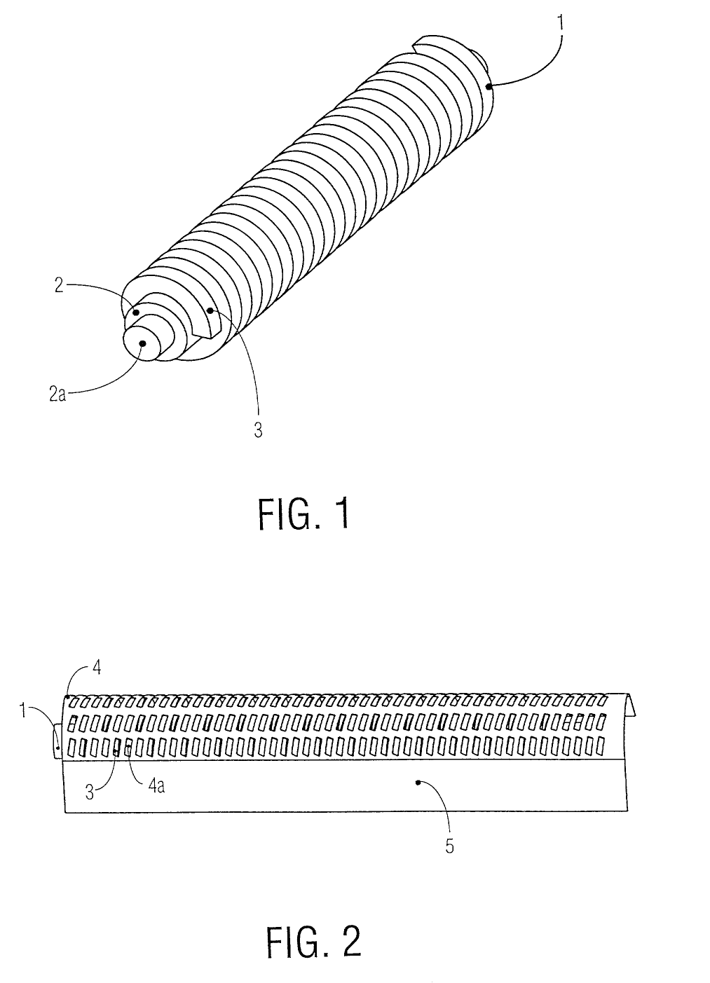

FIG. 1 shows a drum-shaped shaving head having a cutting member which is helically wound around its cylindrical core,

FIG. 2 shows the shaving head disposed underneath shear foil with which it engages tangentially,

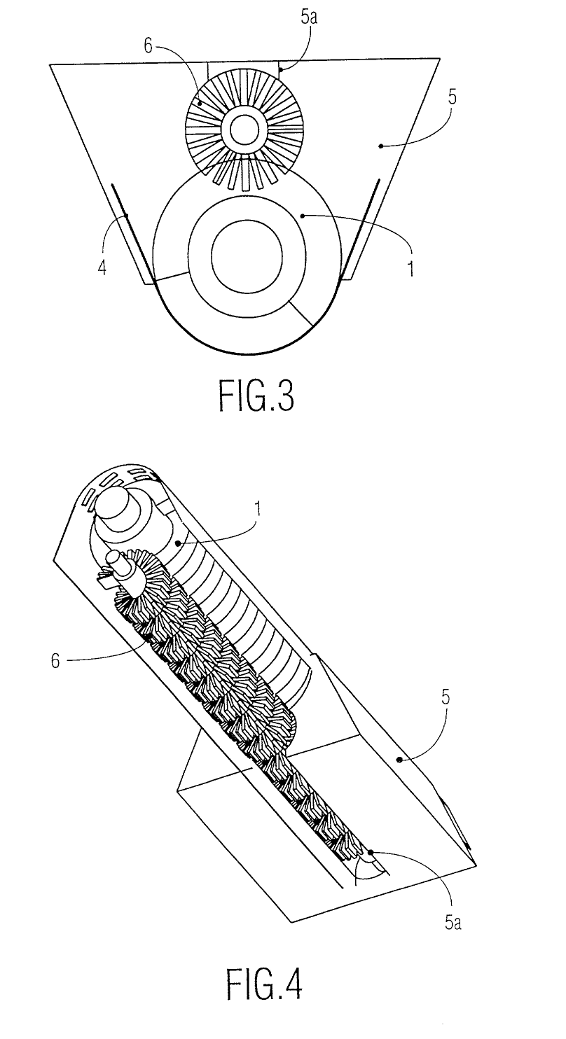

FIG. 3 is a front view of a shaving head with a spiral-shaped brush arranged underneath it,

FIG. 4 is an overall view of the shaving head with the spiral-shaped brush arranged underneath it, and

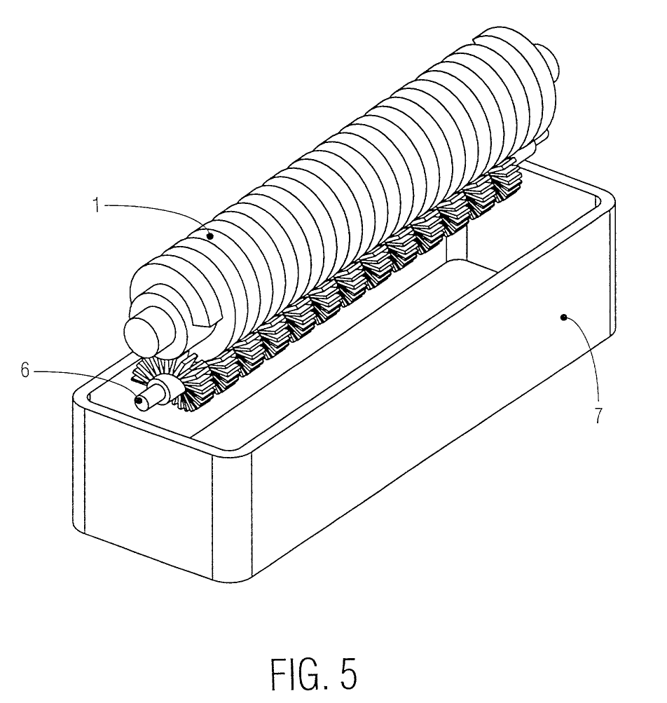

FIG. 5 shows the shaving head with the spiral brush arranged underneath it and with a receptacle for the shaving particles.

The drum-shaped shaving head 1 shown in FIG. 1 has a spiral-shaped cutting member 3 wound around the cylindrical core 2 of the shaving head. At its ends the core 2 has journals 2a for bearings, not shown. Moreover, the core 2 with its two journals 2a serve for cooperation with a drive mechanism or directly with a drive motor, so as to rotate the shaving head 1 about its longitudinal axis. The spiral-shaped cutting member 3 consists of spring wire of preferably rectangular cross-sectional shape, the spring wire being wound around the core 2. The inner diameter of the spiral-shaped cutting member 3 is then slightly smaller than the outer diameter of the core 2. During assembly of the two parts the cutting member 3 is rotated against the direction of its turns in such a manner that it expands. In this position the cutting member 3 is fixed by means of a fixture and is then slid onto the core 2. Subsequently, the fixture is removed and the cutting member 3 tightly fits onto the core 2. Cylindrical grinding of the shaving head is effected on a commercially available cylindrical grinding machine.

For a perfect shaving performance the shaving head 1 cooperates with a shear foil 4 having slits 4a. The slits 4a of the shear foil 4 are adapted to the pitch of the spiral-shaped cutting member 3 so as to obtain an acute angle between the cutting member 3 and the edge of a slit 4a of the shear foil, towards which edge the spiral-shaped cutting member 3 runs in an axial direction. This ensures that the web portions of the shear foil 4, which project slightly into the path of axial movement of the cutting member 3, are always moved up by this cutting member starting at their bases and lifted onto the spiral-shaped cutting member 3, which precludes damage to the web portions of the shear foil 4.

FIGS. 3 and 4 show the cleaning mechanism and a part of the housing 5 which accommodates the shaving unit. The cleaning mechanism consists of a spiral-shaped rotatable brush 6 arranged underneath the shaving head 1 at the side which is remote from the shear foil 4. The bristles of the brush 6 engage in the gaps in the spiral-shaped cutting member 3. The cutting member 3 and the brush 6 have a similar pitch but in opposite directions. During rotation of the shaving head 1 the brush 6 is rotated and thus removes the shaving particles from the shaving head 1. The shaving particles can fall through a slot 5a in the housing 5, where they are collected in a receptacle 7 as shown in FIG. 5. For a simple removal of the shaving particles the receptacle 7 takes the form of a removable drawer, which can be emptied in a simple manner.

1. A shaving apparatus having an electric drive, having a rotary shaving head provided with cutting members (3), and having a shear foil (4), characterized in that a cleaning device (6) is included, which device cleans the shaving head (1) during operation, and the drum-shaped shaving head (1) is rotatable about its longitudinal axis and carries at least one cutting member (3) on the circumference of its cylindrical core (2), which cutting member is rod-shaped and extends in the longitudinal direction of the shaving head (1).

2. A shaving apparatus as claimed in claim 1, characterized in that the cleaning device (6) has at least one brush (6) which is in contact with the cutting members (3) and thereby removes shaving particles from the shaving head (1).

3. A shaving apparatus as claimed in claim 1, characterized in that the shaving head (1) has a cutting member (3) which is wound to a spiral shape around the longitudinal axis of the shaving head (1), and the spiral-shaped cutting member (3) is a spiral-shaped spring of a metal, which spring is secured to the circumference of the cylindrical core (2) of the shaving head (1).

4. A shaving apparatus as claimed in claim 2, characterized in that the cleaning device (6) cleans the shaving head (1) outside the area of contact between the cutting members (9) and the shear foil (4).

5. A shaving apparatus as claimed in claim 3, characterized in that the brush (6) is rotatable and spiral-shaped and engages in the gaps in the spiral-shaped cutting member (3).

6. A shaving apparatus as claimed in claim 2, characterized in that the shaving particles are moved into a receptacle (7) by the centrifugal force produced during rotation of the shaving head (1).

7. A shaving apparatus as claimed in claim 6, characterized in that the shaving particles are moved into a receptacle (7) by the centrifugal force produced during rotation of the shaving head (1) and by an additional transport device.

8. A shaving apparatus as claimed in claim 6 or 7, characterized in that the receptacle (7) is a removable drawer.

9. A shaving apparatus as claimed in claim 1, characterized in that the shear foil (4) has slits (4a) which are oriented obliquely at an acute angle with respect to the pitch of the cutting member (3).

10. A shaving apparatus as claimed in claim 1, characterized in that the shear foil (4) is tangentially in contact with the cutting member (3) and is urged against the cutting member (3) under the influence of a load, particularly a spring load.
